(19) United States
(12) Patent Application Publication
(10) Pub. No.: US 2024/0028506 A1
(43) Pub. Date: Jan. 25, 2024

(54) MAPPING TABLE RE-BUILDING METHOD, MEMORY STORAGE DEVICE AND MEMORY CONTROL CIRCUIT UNIT

(71) Applicant: Hefei Core Storage Electronic Limited, Anhui (CN)

(72) Inventors: Chih-Ling Wang, Anhui (CN); Qi-Ao Zhu, Anhui (CN); Yuting Niu, Anhui (CN); Yang Zhang, Anhui (CN)

(73) Assignee: Hefei Core Storage Electronic Limited, Anhui (CN)

(21) Appl. No.: 17/882,610

(22) Filed: Aug. 8, 2022

(30) Foreign Application Priority Data
Jul. 19, 2022 (CN) 202210847451.3

(51) Int. Cl. G06F 12/02; G06F 11/07

(52) U.S. Cl. CPC G06F 12/0246; G06F 12/0292; G06F 11/0772

(57) ABSTRACT

A mapping table re-building method, a memory storage device and a memory control circuit unit are disclosed. The method includes: receiving write command from a host system, wherein the write command instructs storing first data to a first logical unit; performing a programming operation according to the write command to store the first data and identification information of the first logical unit to a first physical unit; updating a mapping table in response to the programming operation; detecting a table abnormal event related to the mapping table; reading the identification information of the first logical unit from the first physical unit in response to the table abnormal event; and re-building the mapping table according to the identification information of the first logical unit.

### CROSS-REFERENCE TO RELATED APPLICATION

This application claims the priority benefit of China application serial no. 202210847451.3, filed on Jul. 19, 2022. The entirety of the above-mentioned patent application is hereby incorporated by reference herein and made a part of this specification.

### BACKGROUND

### Technical Field

The disclosure relates to a memory management technology, and in particular relates to a mapping table re-building method, a memory storage device, and a memory control circuit unit.

### Description of Related Art

As smartphones, tablets, and personal computers have grown rapidly in recent years, the demand of the consumers for storage media has also increased rapidly. Since a rewritable non-volatile memory module (e.g. a flash memory) has the characteristics of data non-volatility, power saving, small size, and having no mechanical structure, it is very suitable for being built in a variety of portable multimedia devices as exemplified above.

Generally speaking, when data is to be stored in the rewritable non-volatile memory module, a memory controller stores the mapping information related to the data in a mapping table. For example, the mapping information may reflect the mapping information between the logical address to which the data belongs and the physical address actually used to store the data. Then, when the data is to be read, the memory controller may obtain the physical address for storing the data according to the above-mentioned mapping information in the mapping table, and read the data from the physical address. However, once the mapping table is abnormal (for example, the table is damaged or the data is read abnormally), the memory controller is not able to successfully complete the data access operation.

### SUMMARY

In view of this, the disclosure provides a mapping table re-building method, a memory storage device, and a memory control circuit unit, which may improve the re-building efficiency of the mapping table.

An exemplary embodiment of the disclosure provides a mapping table re-building method, which is used in a rewritable non-volatile memory module, the rewritable non-volatile memory module includes multiple physical units, and the mapping table re-building method includes the following process. A write command is received from a host system, in which the write command instructs storing first data to a first logical unit. A programming operation is performed according to the write command to store the first data and identification information of the first logical unit to a first physical unit of the physical units. In response to the programming operation, a mapping table is updated. A table abnormal event related to the mapping table is detected. In response to the table abnormal event, the identification information of the first logical unit is read from the first physical unit. A table re-building operation is performed according to the identification information of the first logical unit, to re-build the mapping table.

An exemplary embodiment of the disclosure further provides a memory storage device, which includes a connection interface unit, a rewritable non-volatile memory module, and a memory control circuit unit. The connection interface unit is used to couple to a host system. The rewritable non-volatile memory module includes multiple physical units. The memory control circuit unit is coupled to the connection interface unit and the rewritable non-volatile memory module. The memory control circuit unit is used for the following process. A write command is received from a host system, in which the write command instructs storing first data to a first logical unit. A programming operation is performed according to the write command to store the first data and identification information of the first logical unit to a first physical unit of the physical units. In response to the programming operation, a mapping table is updated. A table abnormal event related to the mapping table is detected. In response to the table abnormal event, the identification information of the first logical unit is read from the first physical unit. A table re-building operation is performed according to the identification information of the first logical unit, to re-build the mapping table.

An exemplary embodiment of the disclosure further provides a memory control circuit unit, which includes a host interface, a memory interface, and a memory management circuit. The host interface is used to couple to a host system. The memory interface is used to couple to a rewritable non-volatile memory module. The rewritable non-volatile memory module includes multiple physical units. The memory management circuit is coupled to the host interface and the rewritable non-volatile memory module. The memory management circuit unit is used for the following process. A write command is received from a host system, in which the write command instructs storing first data to a first logical unit. A programming operation is performed according to the write command to store the first data and identification information of the first logical unit to a first physical unit of the physical units. In response to the programming operation, a mapping table is updated. A table abnormal event related to the mapping table is detected. In response to the table abnormal event, the identification information of the first logical unit is read from the first physical unit. A table re-building operation is performed according to the identification information of the first logical unit, to re-build the mapping table.

Based on the above, after receiving a write command instructing a writing of the first data to the first logical unit from the host system, a programming operation may be performed according to the write command to store the first data and the identification information of the first logical unit in the first physical unit. At the same time, in response to the programming operation, the mapping table may be updated. After detecting a table abnormal event related to the mapping table, in response to the table abnormal event, the identification information of the first logical unit may be read from the first physical unit and used to re-build the mapping table. Thereby, the re-building efficiency of the mapping table may be effectively improved.

### BRIEF DESCRIPTION OF THE DRAWING

FIG. 1 is a schematic diagram of a host system, a memory storage device, and an input/output (I/O) device according to an exemplary embodiment of the disclosure.

FIG. 2 is a schematic diagram of a host system, a memory storage device, and an I/O device according to an exemplary embodiment of the disclosure.

FIG. 3 is a schematic diagram of a host system and a memory storage device according to an exemplary embodiment of the disclosure.

FIG. 4 is a schematic diagram of a memory storage device according to an exemplary embodiment of the disclosure.

FIG. 5 is a schematic diagram of a memory control circuit unit according to an exemplary embodiment of the disclosure.

FIG. 6 is a schematic diagram of managing a rewritable non-volatile memory module according to an exemplary embodiment of the disclosure.

FIG. 7 is a schematic diagram of a first logical unit storing first data and identification information according to an exemplary embodiment of the disclosure.

FIG. 8 is a schematic diagram of a table re-building operation according to an exemplary embodiment of the disclosure.

FIG. 9 is a flowchart of a mapping table re-building method according to an exemplary embodiment of the disclosure.

### DETAILED DESCRIPTION OF DISCLOSED EMBODIMENTS

In general, a memory storage device (also referred to as a memory storage system) includes a rewritable non-volatile memory module and a controller (also referred to as a control circuit). The memory storage device may be used with a host system so that the host system may write data to or read data from the memory storage device.

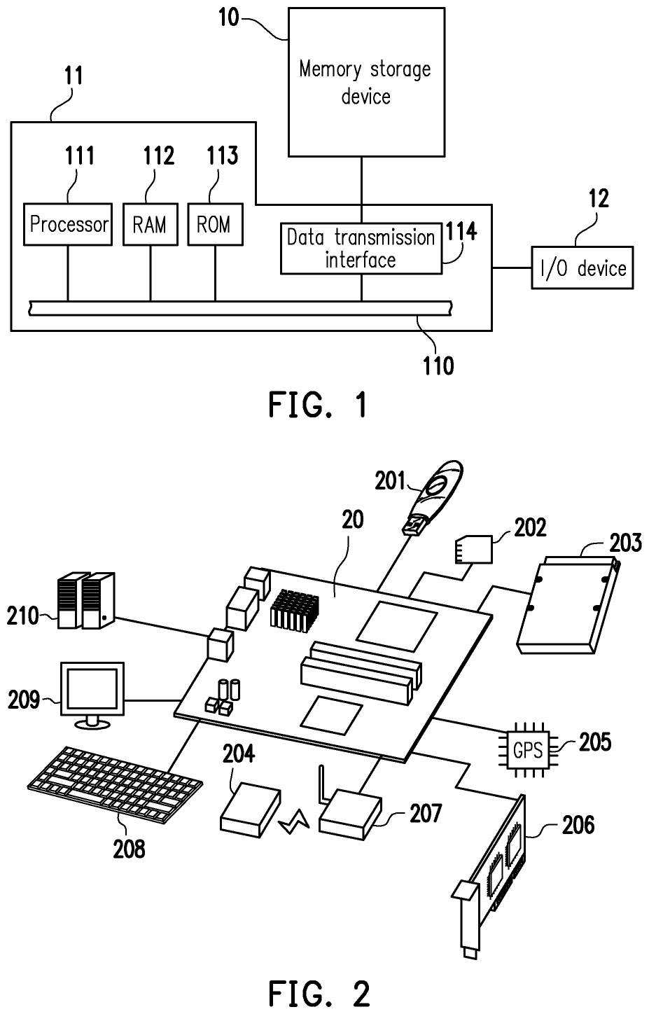

FIG. 1 is a schematic diagram of a host system, a memory storage device, and an input/output (I/O) device according to an exemplary embodiment of the disclosure. FIG. 2 is a schematic diagram of a host system, a memory storage device, and an I/O device according to an exemplary embodiment of the disclosure.

Referring to FIG. 1 and FIG. 2, a host system 11 may include a processor 111, a random access memory (RAM) 112, a read only memory (ROM) 113, and a data transmission interface 114. The processor 111, the random access memory 112, the read only memory 113, and the data transmission interface 114 may be coupled to a system bus 110.

In an exemplary embodiment, the host system 11 may be coupled to a memory storage device 10 through the data transfer interface 114. For example, the host system 11 may store data to or read data from the memory storage device 10 via the data transmission interface 114. In addition, the host system 11 may be coupled to an I/O device 12 through the system bus 110. For example, the host system 11 may transmit output signals to or receive input signals from the I/O device 12 via the system bus 110.

In an exemplary embodiment, the processor 111, the random access memory 112, the read only memory 113, and the data transmission interface 114 may be disposed on a motherboard 20 of the host system 11. The number of the data transmission interface 114 may be one or more. The motherboard 20 may be coupled to the memory storage device 10 through the data transmission interface 114 via a wired or wireless connection.

In an exemplary embodiment, the memory storage device 10 may be, for example, a flash drive 201, a memory card 202, a solid state drive (SSD) 203, or a wireless memory storage device 204. The wireless memory storage device 204 may be a memory storage device based on various wireless communication technologies, such as a near field communication (NFC) memory storage device, a wireless fax (WiFi) memory storage device, a Bluetooth memory storage device, a low power Bluetooth memory storage device (e.g. iBeacon), etc. In addition, the motherboard 20 may also be coupled to various I/O devices, such as a global positioning system (GPS) module 205, a network interface card 206, a wireless transmission device 207, a keyboard 208, a screen 209, a speaker 210, etc., through the system bus 110. For example, in an exemplary embodiment, the motherboard 20 may access the wireless memory storage device 204 through the wireless transmission device 207.

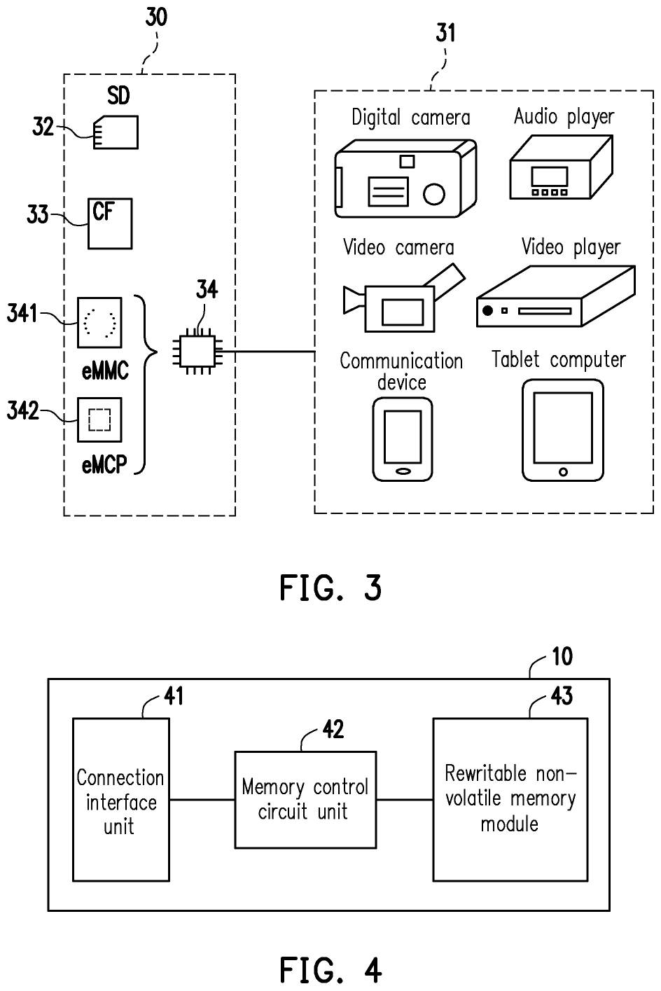

In an exemplary embodiment, the host system 11 is a computer system. In an exemplary embodiment, the host system 11 may be any system that may substantially cooperate with a memory storage device to store data. In an exemplary embodiment, the memory storage device 10 and the host system 11 may respectively include the memory storage device 30 and the host system 31 of FIG. 3.

FIG. 3 is a schematic diagram of a host system and a memory storage device according to an exemplary embodiment of the disclosure. Referring to FIG. 3, the memory storage device 30 may be used in conjunction with the host system 31 to store data. For example, the host system 31 may be a digital camera, a video camera, a communication device, an audio player, a video player, or a tablet computer system. For example, the memory storage device 30 may be various non-volatile memory storage devices, such as a secure digital (SD) card 32, a compact flash (CF) card 33, or an embedded storage device 34, etc., used in the host system 31. The embedded storage device 34 includes various embedded storage devices that directly couple a memory module to a substrate of the host system, such as an embedded multimedia card (eMMC) 341 and/or an embedded multi-chip package (eMCP) storage device 342, etc.

FIG. 4 is a schematic diagram of a memory storage device according to an exemplary embodiment of the disclosure. Referring to FIG. 4, the memory storage device 10 includes a connection interface unit 41, a memory control circuit unit 42, and a rewritable non-volatile memory module 43.

The connection interface unit 41 is used to couple the memory storage device 10 to the host system 11. The memory storage device 10 may communicate with the host system 11 via the connection interface unit 41. In an exemplary embodiment, the connection interface unit 41 is compatible with the peripheral component interconnect express (PCI Express) standard. In an exemplary embodiment, the connection interface unit 41 may also be compliant to the serial advanced technology attachment (SATA) standard, the parallel advanced technology attachment (PATA) standard, the institute of electrical and electronics engineers (IEEE) 1394 standard, the universal serial bus (USB) standard, the SD interface standard, the ultra high speed-I (UHS-I) interface standard, the ultra high speed-II (UHS-II) interface standard, the memory stick (MS) interface standard, the MCP interface standard, the MMC interface standard, the eMMC interface standard, the universal flash storage (UFS) interface standard, the eMCP interface standard, the CF interface standard, the integrated device electronics (IDE) standard, or other suitable standards. The connection interface unit 41 may be packaged in a chip with the memory controlling circuit unit 42, or the connection interface unit 41 may be disposed outside a chip including the memory controlling circuit unit 42.

The memory control circuit unit 42 is coupled to the connection interface unit 41 and the rewritable non-volatile memory module 43. The memory control circuit unit 42 is used to execute multiple logic gates or control commands implemented in a hardware form or a firmware form and to perform operations such as writing, reading, and erasing of data in the rewritable non-volatile memory module 43 according to the commands of the host system 11.

The rewritable non-volatile memory module 43 is used to store the data written by the host system 11. The rewritable non-volatile memory module 43 may include a single level cell (SLC) NAND-type flash memory module (i.e., a flash memory that may store 1 bit in one memory cell), multi-level cell (MLC) NAND-type flash memory module (i.e., a flash memory module that may store 2 bits in one memory cell), a triple level cell (TLC) NAND-type flash memory module (i.e., a flash memory module that may store 3 bits in one memory cell), a quad level cell (QLC) NAND-type flash memory module (i.e., a flash memory module that may store 4 bits in one memory cell), other flash memory modules, or other memory modules with the same characteristics.

Each of the memory cells in the rewritable non-volatile memory module 43 stores one or more bits by a change in a voltage (also referred to as a threshold voltage hereinafter). Specifically, there is a charge trapping layer between a control gate and a channel of each of the memory cells. By applying a write voltage to the control gate, the amount of electrons in the charge trapping layer may be changed, thereby changing the threshold voltage of the memory cell. This operation of changing the threshold voltage of the memory cell is also referred to as “writing data to the memory cell” or “programming the memory cell”. As the threshold voltage changes, each of the memory cells in the rewritable non-volatile memory module 43 has multiple storage states. By applying a read voltage, it may be determined which storage state a memory cell belongs to, thereby obtaining the one or more bits stored in the memory cell.

In an exemplary embodiment, the memory cells of the rewritable non-volatile memory module 43 may constitute multiple physical programming units, and the physical programming units may constitute multiple physical erasing units. Specifically, memory cells on the same word line may form one or more physical programming units. If each of the memory cells may store two or more bits, the physical programming units on the same word line may be classified at least as lower physical programming units and upper physical programming units. For example, the least significant bit (LSB) of a memory cell belongs to a lower physical programming unit, and the most significant bit (MSB) of a memory cell belongs to an upper physical programming unit. Generally, in an MLC NAND flash memory, the write speed of the lower physical programming unit is greater than the write speed of the upper physical programming unit, and/or the reliability of the lower physical programming unit is higher than the reliability of the upper physical programming unit.

In an exemplary embodiment, the physical programming unit is the minimum unit for programming. That is, the physical programming unit is the minimum unit for write data. For example, the physical programming unit may be a physical page or a physical sector. If the physical programming unit is a physical page, then the physical programming unit may include a data bit area and a redundancy bit area. The data bit area includes multiple physical sectors is used to store user data, and the redundancy bit area is used to store system data (e.g., management data such as error correction codes). In an exemplary embodiment, the data bit area includes 32 physical sectors, and the size of a physical sector is 512 bytes (B). However, in other exemplary embodiments, the data bit area may also include 8, 16, or a greater or lesser number of physical sectors, and the size of each of the physical sectors may also be larger or smaller. On the other hand, the physical erasing unit is the minimum unit for erasing. That is, each of the physical erasing units includes the smallest number of memory cells to be erased together. For example, the physical erasing unit is a physical block.

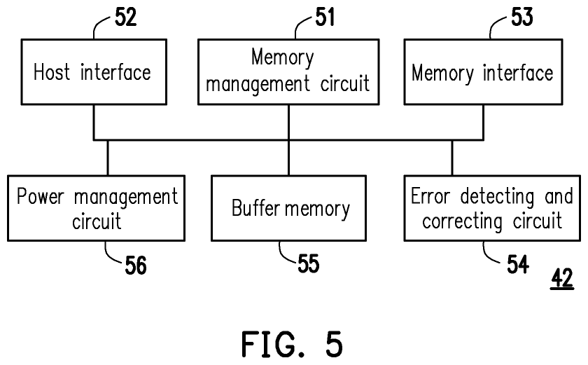

FIG. 5 is a schematic diagram of a memory control circuit unit according to an exemplary embodiment of the disclosure. Referring to FIG. 5, the memory control circuit unit 42 includes a memory management circuit 51, a host interface 52, and a memory interface 53.

The memory management circuit 51 is used to control the overall operation of the memory control circuit unit 42. Specifically, the memory management circuit 51 has multiple control commands, and when the memory storage device 10 operates, the control commands are executed to perform operations such as writing, reading, and erasing data. The following description of the operation of the memory management circuit 51 is equivalent to the description of the operation of the memory control circuit unit 42.

In an exemplary embodiment, the control commands of the memory management circuit 51 are implemented in a firmware form. For example, the memory management circuit 51 has a microprocessor unit (not shown) and a read only memory (not shown), and the control commands are programmed into the read only memory. When the memory storage device 10 operates, the control commands are executed by the microprocessor unit to perform operations such as writing, reading, and erasing data.

In an exemplary embodiment, the control commands of the memory management circuit 51 may also be stored in a specific area of the rewritable non-volatile memory module 43 (for example, a system area dedicated to storing system data in the memory module) in a program code form. In addition, the memory management circuit 51 has a microprocessor unit (not shown), a read-only memory (not shown) and a random access memory (not shown). In particular, the read only memory has a boot code, and when the memory control circuit unit 42 is enabled, the microprocessor unit first executes the boot code to load the control commands stored in the rewritable non-volatile memory module 43 into the random access memory of the memory management circuit 51. Thereafter, the microprocessor unit runs these control commands to perform operations such as writing, reading, and erasing data.

In an exemplary embodiment, the control commands of the memory management circuit 51 may also be implemented in a hardware form. For example, the memory management circuit 51 includes a microcontroller, a memory cell management circuit, a memory writing circuit, a memory reading circuit, a memory erasing circuit, and a data processing circuit. The memory cell management circuit, the memory writing circuit, the memory reading circuit, the memory erasing circuit, and the data processing circuit are coupled to the microcontroller. The memory cell management circuit is used to manage the memory cells or a memory cell group of the rewritable non-volatile memory module 43. The memory writing circuit is used to issue a write command sequence to the rewritable non-volatile memory module 43 to write data into the rewritable non-volatile memory module 43. The memory reading circuit is used to issue a read command sequence to the rewritable non-volatile memory module 43 to read data from the rewritable non-volatile memory module 43. The memory erasing circuit is used to issue an erase command sequence to the rewritable non-volatile memory module 43 to erase data from the rewritable non-volatile memory module 43. The data processing circuit is used to process the data to be written into the rewritable non-volatile memory module 43 and the data read from the rewritable non-volatile memory module 43. The write command sequence, the read command sequence and the erase command sequence may respectively include one or more program codes or command codes for instructing the rewritable non-volatile memory module 43 to perform corresponding writing, reading, and erasing operations. In an exemplary embodiment, the memory management circuit 51 may also issue other types of command sequences to the rewritable non-volatile memory module 43 to instruct the rewritable non-volatile memory module 43 to perform corresponding operations.

The host interface 52 is coupled to the memory management circuit 51. The memory management circuit 51 may communicate with the host system 11 through the host interface 52. The host interface 52 may be used to receive and identify the commands and data transmitted by the host system 11. For example, the commands and data transmitted by the host system 11 may be transmitted to the memory management circuit 51 through the host interface 52. In addition, the memory management circuit 51 may transmit data to the host system 11 through the host interface 52. In this exemplary embodiment, the host interface 52 is compatible with the PCI Express standard. However, it should be understood that the disclosure is not limited thereto, and the host interface 52 may also be compatible with the SATA standard, the PATA standard, the IEEE 1394 standard, the USB standard, the SD standard, the UHS-I standard, the UHS-II standard, the MS standard, the MMC standard, the eMMC standard, the UFS standard, the CF standard, the IDE standard, or other suitable data transmission standards.

The memory interface 53 is coupled to the memory management circuit 51 and is used to access the rewritable non-volatile memory module 43. For example, the memory management circuit 51 may access the rewritable non-volatile memory module 43 through the memory interface 53. In other words, the data to be written into the rewritable non-volatile memory module 43 is converted into a format acceptable to the rewritable non-volatile memory module 43 via the memory interface 53. Specifically, if the memory management circuit 51 is to access the rewritable non-volatile memory module 43, the memory interface 53 transmits a corresponding command sequence. For example, the command sequences may include a write command sequence to instruct data writing, a read command sequence to instruct data reading, an erase command sequence to instruct data erasing, and corresponding command sequences for instructing various memory operations (e.g., changing the read voltage level, performing a garbage collection operation, etc.). These command sequences are, for example, generated by the memory management circuit 51 and transmitted to the rewritable non-volatile memory module 43 via the memory interface 53. These command sequences may include one or more signals or data on the bus. The signals or data may include command codes or program codes. For example, the read command sequence includes information such as the read identification code, the memory address, etc.

In an exemplary embodiment, the memory control circuit unit 42 further includes an error detecting and correcting circuit 54, a buffer memory 55, and a power management circuit 56.

The error detecting and correcting circuit 54 is coupled to the memory management circuit 51 and is used to perform an error detecting and correcting operation to ensure the correctness of the data. Specifically, when the memory management circuit 51 receives a write command from the host system 11, the error detecting and correcting circuit 54 generates a corresponding error correcting code (ECC) and/or error detecting code (EDC) for the data corresponding to the write command, and the memory management circuit 51 writes the data corresponding to the write command and the corresponding error correcting code and/or error detecting code to the rewritable non-volatile memory module 43. Thereafter, when the memory management circuit 51 reads data from the rewritable non-volatile memory module 43, it simultaneously reads the error correcting code and/or the error detecting code corresponding to the data, and the error detecting and correcting circuit 54 performs the error detecting and correcting operation on the read data according to the error correcting code and/or error detecting code.

The buffer memory 55 is coupled to the memory management circuit 51 and used to temporarily store data. The power management circuit 56 is coupled to the memory management circuit 51 and is used to control the power of the memory storage device 10.

In an exemplary embodiment, the rewritable non-volatile memory module 43 of FIG. 4 may include a flash memory module. In an exemplary embodiment, the memory control circuit unit 42 of FIG. 4 may include a flash memory controller. In an exemplary embodiment, the memory management circuit 51 of FIG. 5 may include a flash memory management circuit.

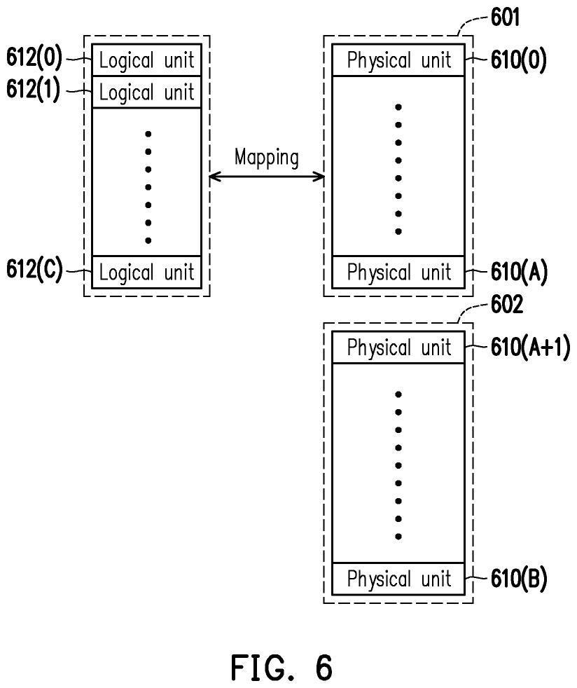

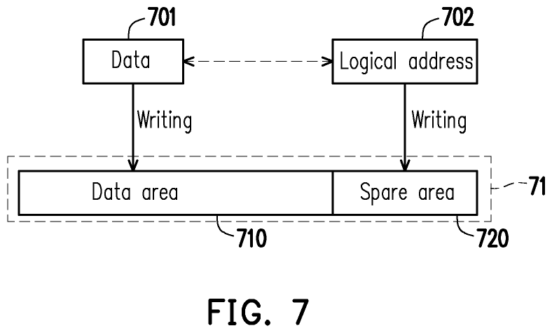

FIG. 6 is a schematic diagram of managing a rewritable non-volatile memory module according to an exemplary embodiment of the disclosure. Referring to FIG. 6, the memory management circuit 51 may logically group the physical units 610(0) to 610(B) in the rewritable non-volatile memory module 43 into a storage area 601 and a spare area 602.

In an exemplary embodiment, a physical unit refers to a physical address or a physical programming unit. In an exemplary embodiment, a physical unit may also be formed by multiple consecutive or non-consecutive physical addresses.

The physical units 610(0) to 610(A) in the storage area 601 are used to store user data (e.g., user data from the host system 11 of FIG. 1). For example, the physical units 610(0)-610(A) in the storage area 601 may store valid data and invalid data. The physical units 610(A+1) to 610(B) in the spare area 602 do not store data (e.g., valid data). For example, if a certain physical unit does not store valid data, this physical unit may be associated (or added) to the spare area 602. In addition, the physical units in the spare area 602 (or the physical units not storing valid data) may be erased. When new data is written, one or more physical units may be extracted from the spare area 602 to store the new data. In an exemplary embodiment, the spare area 602 is also referred to as a free pool.

The logical units 612(0) to 612(C) may be configured in the memory management circuit 51 to map the physical units 610(0) to 610(A) in the storage area 601. In an exemplary embodiment, each of the logical units corresponds to a logical address. For example, a logical address may include one or more logical block addresses (LBA) or other logical management units. In an exemplary embodiment, a logical unit may also correspond to a logical programming unit or be formed by multiple consecutive or non-consecutive logical addresses.

It should be noted that a logical unit may be mapped to one or more physical units. If a certain physical unit is currently mapped by a certain logical unit, it means that the data currently stored in this physical unit includes valid data. On the contrary, if a certain physical unit is not currently mapped by any logical unit, it means that the data currently stored in this physical unit is invalid data.

The memory management circuit 51 may record the mapping information (also referred to as the logical to physical mapping information) describing the mapping relationship between logical units and physical units in at least one mapping table (also referred to as the logical to physical mapping table). When the host system 11 reads data from the memory storage device 10 or writes data to the memory storage device 10, the memory management circuit 51 may access the rewritable non-volatile memory module 43 according to the information in the mapping table (i.e., the mapping information).

In an exemplary embodiment, the memory management circuit 51 may receive a write command from the host system 11. The write command is used to instruct to store specific data (also referred to as the first data) to a specific logical unit (also referred to as the first logical unit). For example, the first logical unit may include one of the logical units 612(0) to 612(C) in FIG. 6. The memory management circuit 51 may perform a programming operation (or referred to as a write operation) according to the write command. During the programming operation, the memory management circuit 51 may instruct the rewritable non-volatile memory module 43 to store the first data and the identification information of the first logical unit in a specific physical unit (also referred to as the first physical unit). For example, the identification information of the first logical unit includes address information of the first logical unit. For example, the address information of the first logical unit may include a logical address corresponding to the first logical unit. In addition, the first physical unit may include one of the physical units 610(0) to 610(B) in FIG. 6.

FIG. 7 is a schematic diagram of a first logic unit storing first data and identification information according to an exemplary embodiment of the disclosure. Referring to FIG. 7, it is assumed that the first data includes data 701, the address information of the first logical unit includes a logical address 702 corresponding to the first logical unit, and the first physical unit includes the physical unit 71.

After receiving the write command instructing to store the data 701, in response to the write command, the memory management circuit 51 may perform a programming operation to synchronously store (or write) the data 701 and the logical address 702 to the data area 710 and the spare area 720 in the physical unit 71. For example, the data area 710 may include the data bit area in the physical unit 71, and the spare area 720 may include the redundancy bit area in the physical unit 71.

On the other hand, in response to the programming operation, the memory management circuit 51 may update the mapping table. For example, the memory management circuit 51 may store the mapping information related to the first data in the mapping table. In particular, the mapping information may reflect the mapping relationship between the first logical unit and the first physical unit. After updating the mapping table, the memory management circuit 51 may read the first data from the first physical unit according to the mapping information in the mapping table. For example, when the first data is to be read, the memory management circuit 51 may read the mapping information related to the first data from the mapping table. The memory management circuit 51 may obtain the mapping relationship between the first logical unit and the first physical unit according to the mapping information. Then, the memory management circuit 51 may instruct the rewritable non-volatile memory module 43 to read the first data from the first physical unit according to the mapping relationship.

In an exemplary embodiment, the memory management circuit 51 may detect an abnormal event (also referred to as a table abnormal event) related to the mapping table. For example, the memory management circuit 51 may receive a read command from the host system 11. The read command is used to instruct to read data (i.e., the first data) from the first logical unit. The memory management circuit 51 may perform a table query operation according to the read command, so as to try to read the mapping information related to the first data from the mapping table. If the mapping information related to the first data may be successfully read from the mapping table, the memory management circuit 51 may read the first data from the first physical unit according to the mapping information.

On the other hand, in response to the mapping information not being able to be read correctly, the memory management circuit 51 may determine that a table abnormal event related to the mapping table has occurred. For example, when an error event occurs, such as table corruption, table data loss, or information read from the mapping table containing too many errors, such that the information in the mapping table (i.e., the mapping information) may not be read correctly, the memory management circuit 51 may determine that a table abnormal event related to the mapping table has occurred.

In an exemplary embodiment, the memory management circuit 51 may perform a table scan operation to scan the mapping table periodically or under certain conditions (e.g., when the memory storage device 10 is in an idle state, executing a shutdown procedure, or executing a boot procedure). For example, in a table scan operation, the memory management circuit 51 may attempt to read out and decode the information in the mapping table (ie, mapping information) one by one. When the decoding result reflects that a specific information in the mapping table has an error, the memory management circuit 51 may attempt to correct the error and store the updated mapping information again to the mapping table.

In an exemplary embodiment, in response to an abnormality in the scanning of the mapping table, the memory management circuit 51 may determine that a table abnormal event related to the mapping table occurs. For example, when an error event occurs, such as table corruption, table data loss, or information read from the mapping table containing too many errors, which results in an abnormality in scanning the mapping table, the memory management circuit 51 may determine that a table abnormal event related to the mapping table has occurred.

In an exemplary embodiment, in response to the table abnormal event, the memory management circuit 51 may read the identification information of the first logical unit from the first physical unit. Then, the memory management circuit 51 may perform a table re-building operation according to the identification information to re-build the mapping table.

Taking FIG. 7 as an example, in the table re-building operation, the memory management circuit 51 may read the logical address 702 (i.e., the identification information of the first logical unit) from the physical unit 71. The memory management circuit 51 may establish a mapping relationship between the first physical unit and the first logical unit according to the address information of the physical unit 71 currently used to store the data 701 (i.e., the physical address of the physical unit 71) and the logical address 702. Then, the memory management circuit 51 may re-build the mapping table according to the mapping relationship. For example, the memory management circuit 51 may store the mapping information describing the mapping relationship in the re-built mapping table.

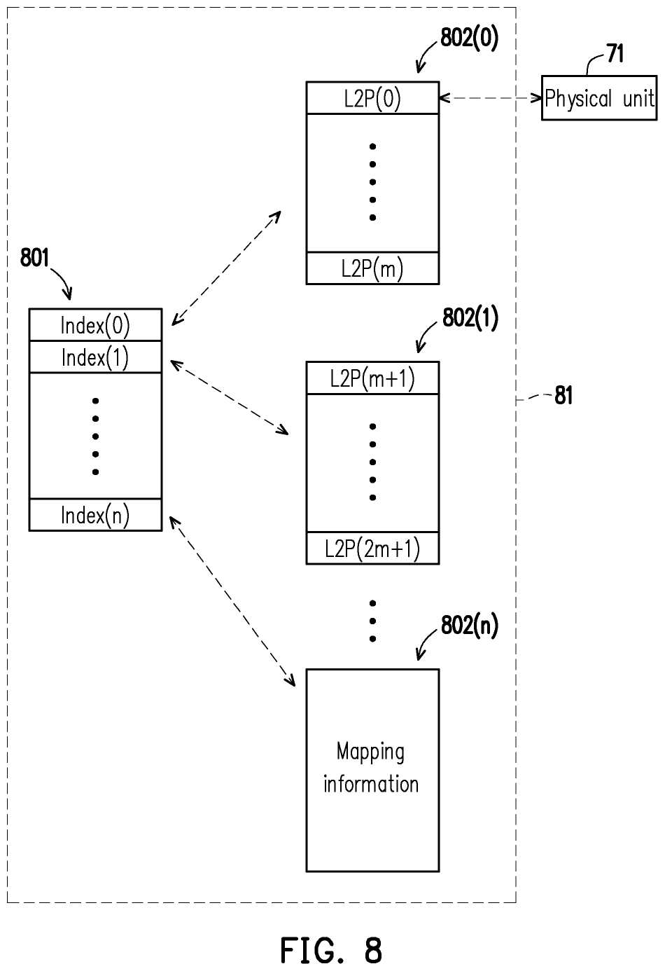

FIG. 8 is a schematic diagram of a table re-building operation according to an exemplary embodiment of the disclosure. Referring to FIG. 8, it is assumed that a mapping table 81 includes an index table 801 and sub-mapping tables 802(0) to 802(n). The index table 801 is used to record the index information Index(0) to Index(n). The index information Index(0) to Index(n) respectively correspond to the sub-mapping tables 802(0) to 802(n). For example, the index information Index(i) corresponds to the sub-mapping table 802(i).

Each of the sub-mapping tables in the sub-mapping tables 802(0) to 802(n) is used to record the mapping information (i.e., the logical to physical mapping information) related to multiple logical units within a specific logical scope. For example, the sub-mapping table 802(0) is used to record the mapping information L2P(0) to L2P(m) related to multiple logical units in a certain logical scope (also referred to as the first logical scope), and the sub-mapping table 802(1) is used to record the mapping information L2P(m+1) to L2P(2m+1) related to multiple logical units in another logical scope (also referred to as the second logical scope), and so on.

Referring to FIG. 7 and FIG. 8, it is assumed that the data 701 stored in the physical unit 71 belongs to the logical address 702, and the logical address 702 is located in the logical scope that the sub-mapping table 802(0) is responsible for or corresponds to. In the table re-building operation for the mapping table 81 (or the sub-mapping table 802(0)), the memory management circuit 51 may read the logical address 702 from the physical unit 71 (i.e., the identification information of the first logical unit), and store the mapping information L2P(0) to the sub-mapping table 802(0) again. For example, the mapping information L2P(0) may be used to describe the mapping relationship between the first logical unit and the first physical unit. By analogy, in the table re-building operation for the mapping table 81 (or any one of the sub-mapping tables 802(0) to 802(n)), the memory management circuit 51 may read the identification information of each of the logical units from the relevant physical unit, and gradually update the mapping information in each of the (sub) mapping tables according to the identification information. In this way, the table re-building operation may be gradually completed.

It should be noted that the exemplary embodiment of FIG. 8 uses a two-layer table management structure to manage the mapping table 81 as an example (that is, the index table 801 is located in the first layer, and the sub-mapping tables 802(0) to 802(n) are located in the second layer), but the disclosure is not limited thereto. In another exemplary embodiment, the mapping table 81 may also be implemented as a single-layer table management structure or a multi-layer table management structure, which is not limited in the disclosure.

It should be noted that, in the foregoing exemplary embodiments, the first data and the identification information of the first logical unit are stored in the same physical unit as an example, but the disclosure is not limited thereto. In another exemplary embodiment, the first data and the identification information of the first logical unit may also be stored in different physical units, depending on practical requirements.

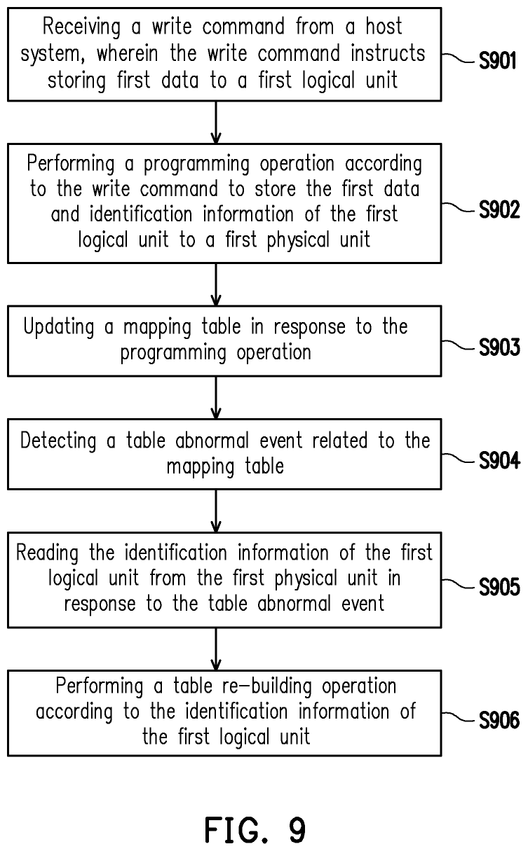

FIG. 9 is a flowchart of a mapping table re-building method according to an exemplary embodiment of the disclosure. Referring to FIG. 9, in step S901, a write command is received from the host system, in which the write command instructs to store the first data to the first logical unit. In step S902, a programming operation is performed according to the write command to store the first data and the identification information of the first logical unit in the first physical unit. In step S903, in response to the programming operation, the mapping table is updated. In step S904, a table abnormal event related to the mapping table is detected. In step S905, in response to the table abnormal event, the identification information of the first logical unit is read from the first physical unit. In step S906, the mapping table is re-built according to the identification information of the first logical unit.

However, each of the steps in FIG. 9 has been described in detail as above, and are not repeated herein. It should be noted that each of the steps in FIG. 9 may be implemented as multiple program codes or circuits, and the disclosure is not limited thereto. In addition, the method in FIG. 9 may be used in conjunction with the above-mentioned exemplary embodiments, or may be used alone, and the disclosure is not limited thereto.

To sum up, the exemplary embodiment of the disclosure proposes to store the data and the identification information of the logical unit to which the data belongs together in the physical unit when the data is stored. Thereafter, when a table abnormal event related to the mapping table is detected, the identification information of the logical unit stored in the physical unit may be used to re-build the mapping table. Thereby, the re-building efficiency of the mapping table may be effectively improved.

Although the disclosure has been described in detail with reference to the above embodiments, they are not intended to limit the disclosure. Those skilled in the art should understand that it is possible to make changes and modifications without departing from the spirit and scope of the disclosure. Therefore, the protection scope of the disclosure shall be defined by the following claims.

What is claimed is:

1. A mapping table re-building method, used in a rewritable non-volatile memory module, the rewritable non-volatile memory module comprising a plurality of physical units, the mapping table re-building method comprising:
receiving a write command from a host system, wherein the write command instructs storing first data to a first logical unit;
performing a programming operation according to the write command to store the first data and identification information of the first logical unit to a first physical unit of the physical units;
updating a mapping table in response to the programming operation;
detecting a table abnormal event related to the mapping table;
reading the identification information of the first logical unit from the first physical unit in response to the table abnormal event; and
performing a table re-building operation according to the identification information of the first logical unit to re-build the mapping table.

2. The mapping table re-building method according to claim 1, wherein the identification information of the first logic unit comprises address information of the first logic unit.

3. The mapping table re-building method according to claim 1, wherein a step of updating the mapping table in response to the programmed operation comprises:
storing mapping information related to the first data in the mapping table, wherein the mapping information reflects a mapping relationship between the first logical unit and the first physical unit.

4. The mapping table re-building method according to claim 1, wherein a step of detecting the table abnormal event related to the mapping table comprises:
receiving a read command from the host system, wherein the read command instructs to read data from the first logic unit;
performing a table query operation according to the read command to read mapping information related to the first data from the mapping table; and
determining that the table abnormal event has occurred in response to the mapping information not being able to be read correctly.

5. The mapping table re-building method according to claim 1, wherein a step of detecting the table abnormal event related to the mapping table comprises:
performing a table scan operation to scan the mapping table; and
determining that the table abnormal event has occurred in response to an abnormality occurring in a scan of the mapping table.

6. The mapping table re-building method according to claim 1, wherein the first data is stored in a data area of the first physical unit, and the identification information of the first logical unit is stored in a spare area of the first physical unit.

7. A memory storage device, comprising:
a connection interface unit, used to couple to a host system
a rewritable non-volatile memory module, comprising a plurality of physical units; and
a memory control circuit unit, coupled to the connection interface unit and the rewritable non-volatile memory module,
wherein the memory control circuit unit is used to:
receive a write command from a host system, wherein the write command instructs storing first data to a first logical unit;
perform a programming operation according to the write command to store the first data and identification information of the first logical unit to a first physical unit of the physical units;
update a mapping table in response to the programming operation;
detect a table abnormal event related to the mapping table;
read the identification information of the first logical unit from the first physical unit in response to the table abnormal event; and
perform a table re-building operation according to the identification information of the first logical unit to re-build the mapping table.

8. The memory storage device according to claim 7, wherein the identification information of the first logic unit comprises address information of the first logic unit.

9. The memory storage device according to claim 7, wherein an operation of the memory control circuit unit updating the mapping table in response to the programmed operation comprises:
storing mapping information related to the first data in the mapping table, wherein the mapping information reflects a mapping relationship between the first logical unit and the first physical unit. The memory storage device according to claim 7, wherein an operation of the memory control circuit unit detecting the table abnormal event related to the mapping table comprises:
receiving a read command from the host system, wherein the read command instructs to read data from the first logic unit;
performing a table query operation according to the read command to read mapping information related to the first data from the mapping table; and
determining that the table abnormal event has occurred in response to the mapping information not being able to be read correctly.

11. The memory storage device according to claim 7, wherein an operation of the memory control circuit unit detecting the table abnormal event related to the mapping table comprises:
performing a table scan operation to scan the mapping table; and
determining that the table abnormal event has occurred in response to an abnormality occurring in a scan of the mapping table.

12. The memory storage device according to claim 7, wherein the first data is stored in a data area of the first physical unit, and the identification information of the first logical unit is stored in a spare area of the first physical unit.

13. A memory control circuit unit, comprising:
a host interface, used to couple to the host system;
a memory interface, used to couple to a rewritable non-volatile memory module, wherein the rewritable non-volatile memory module comprises a plurality of physical units; and
a memory management circuit, coupled to the host interface and the rewritable non-volatile memory module,
wherein the memory management circuit is used to:
receive a write command from a host system, wherein the write command instructs storing first data to a first logical unit;
perform a programming operation according to the write command to store the first data and identification information of the first logical unit to a first physical unit of the physical units;
update a mapping table in response to the programming operation;
detect a table abnormal event related to the mapping table;
read the identification information of the first logical unit from the first physical unit in response to the table abnormal event; and
perform a table re-building operation according to the identification information of the first logical unit to re-build the mapping table.

14. The memory control circuit unit according to claim 13, wherein the identification information of the first logic unit comprises address information of the first logic unit.

15. The memory control circuit unit according to claim 13, wherein an operation of the memory management circuit updating the mapping table in response to the programmed operation comprises:
storing mapping information related to the first data in the mapping table, wherein the mapping information reflects a mapping relationship between the first logical unit and the first physical unit.

16. The memory control circuit unit according to claim 13, wherein an operation of the memory management circuit detecting the table abnormal event related to the mapping table comprises:
receiving a read command from the host system, wherein the read command instructs to read data from the first logic unit;
performing a table query operation according to the read command to read mapping information related to the first data from the mapping table; and
determining that the table abnormal event has occurred in response to the mapping information not being able to be read correctly.

17. The memory control circuit unit according to claim 13, wherein an operation of the memory management circuit detecting the table abnormal event related to the mapping table comprises:
performing a table scan operation to scan the mapping table; and
determining that the table abnormal event has occurred in response to an abnormality occurring in a scan of the mapping table.

18. The memory control circuit unit according to claim 13, wherein the first data is stored in a data area of the first physical unit, and the identification information of the first logical unit is stored in a spare area of the first physical unit.
